(19) United States
(12) Patent Application Publication
(10) Pub. No.: US 2025/0104004 A1
(43) Pub. Date: Mar. 27, 2025

(54) SYSTEM, SERVER, TERMINAL, METHOD AND COMPUTER PROGRAM FOR SUPPORTING DELIVERY SERVICE BY PROVIDING SIMPLIFIED SHIPPING ADDRESS

(71) Applicant: REXGEN CO., LTD., Anyang-si (KR)

(72) Inventors: Soon Hyun AHN, Anyang-si (KR); Dae Hyun BAEK, Anyang-si (KR); Hee Ra JANG, Anyang-si (KR)

(21) Appl. No.: 18/972,897

(22) Filed: Dec. 7, 2024

Related U.S. Application Data
(63) Continuation of application No. PCT/KR2023/007851, filed on Jun. 8, 2023.

(30) Foreign Application Priority Data
Jun. 10, 2022 (KR) 10-2022-0071052

(51) Int. Cl. G06Q 10/0835

(52) U.S. Cl. CPC G06Q 10/0835

(57) ABSTRACT

A server for supporting delivery service according to the present disclosure includes a data processing unit that generates a minimum unit shipping address in which a shipping address of shipping data is simplified and determines whether the generated minimum unit shipping address is duplicated to generate the simplified shipping address.

### CROSS-REFERENCE TO RELATED APPLICATIONS

This application is a Bypass continuation of pending PCT International Application No. PCT/KR2023/007851, which was filed on Jun. 8, 2023, and which claims priorities under 35 U.S.C 119 (a) to Korean Patent Application No. 10-2022-0071052 filed with the Korean Intellectual Property Office on Jun. 10, 2022. The disclosures of the above patent applications are incorporated herein by reference in their entirety.

### TECHNICAL FIELD

The present invention relates to a technology for supporting a delivery service of a delivery person.

### BACKGROUND ART

Recently, as logistics has rapidly increased due to the activation of online shopping malls such as Internet shopping malls and TV home shopping, many efforts are being made to efficiently operate the flow of logistics.

When the flow of typical logistics is divided into stages, it includes a “pickup stage”, a “cargo collection processing stage”, a “trunk loading stage”, a “trunk unloading stage”, a “delivery release stage”, and a “delivery completion stage”. In this case, a waybill is attached at the “pickup stage” described above.

Products to which the waybills are attached are transported through a conveyor at least 2 to 3 times for classification by region and delivery person, and barcode recognition and video recording are performed during a conveyor transport process.

Meanwhile, logistics companies are making great efforts to optimize a process until a delivery products are delivered to delivery persons, but there is relatively little interest in ways to improve the work efficiency of the delivery persons after the delivery products are delivered to the delivery persons.

A delivery person classifies delivery products according to shipping addresses in each process from “delivery release” to “delivery completion” when the products are finally delivered to recipients.

In this classification process, the delivery persons identify the shipping addresses of the delivery products by checking the waybills, but there was a problem that it was difficult to identify the shipping addresses of the delivery products through the waybills because there was a lot of information written on the waybills.

FIGS. 1A and 1B are an example of conventional methods for identifying a shipping address. FIG. 1A is an example in which a delivery person briefly writes a shipping address by hand on a box of a delivery product to identify the shipping address. That is, the shipping address written on the waybill is ‘Gana Apartment 101-dong 305’, but since the readability of the shipping address written on the waybill was not good, the delivery person simply and largely wrote the shipping address by hand on the box of the delivery product in ‘Ga 101-305’ which is the form that he/she may confirm.

In addition, FIG. 1B is an example of improving the readability of the shipping address of the delivery person by printing the shipping address in the waybill in a relatively large font size compared to other information.

However, the method of FIG. 1A has the problem that it reduces the efficiency and convenience of a delivery service since it does not have a system for simplifying a shipping address and relies on a handwriting record of a delivery person, and it has the problem that it is difficult for anyone other than the writer to identify the shipping address.

In addition, the method of FIG. 1B has only enlarged some of characters of the shipping address, so the shipping address is still mixed with other information, and there is a limit to improving the readability and identifiability of the delivery person.

Meanwhile, Korean Patent No. 10-2205637 (Registration date: Jan. 15, 2021) (hereinafter, Related Patent Document 1) discloses the “invention that provides a shipping address in a readable and visible abbreviation, such as large or bold letters, on a waybill attached to a delivery product, so that a delivery person may intuitively check and classify a detailed location of the delivery product.” As an example, Korean Patent No. 10-2205637 discloses the invention that generates “Naeseorak Apartment 102-dong 103-ho” as an abbreviated address for a shipping address “120-103 Naeseorak Apartment, 6, Inje-ro 228 beon-gil, Inje-eup, Inje-gun, Gangwon-do.”

However, the abbreviated address proposed in the Related Patent Document 1 is composed of a word (representative name) that characterizes the purpose of the building and a detailed address (e.g., building, house number, etc.), and may be viewed as a simplification of the shipping address. However, since the abbreviated address is composed of a large number of characters and contains a large amount of information, there is a problem that the readability and identifiably of the shipping address are poor from the perspective of a delivery person who performs 150 to 200 deliveries per day. In addition, according to the Related Patent Document 1, since many letters indicating the abbreviated address on a limited-size waybill should be enlarged, there is a limitation on the size of the letters, and at the same time, there is a problem that the readability and identifiability are poor due to a string that increases the size of the letters.

### DISCLOSURE

### Technical Problem

The present disclosure has been devised according to the above-described necessity, and an object of the present disclosure provides a technology that automatically generates a simplified shipping address from a shipping address and generates output data that allows a delivery person to easily confirm the generated simplified shipping address.

Technical problems disclosed in the present document are not limited to the above-mentioned objects. That is, other technical problems that are not mentioned may be obviously understood by those skilled in the art from the following description.

### Technical Solution

To achieve the above object, according to an embodiment of the present disclosure, a server for supporting delivery service includes a data processing unit that generates a minimum unit shipping address in which a shipping address of shipping data is simplified and determines whether the generated minimum unit shipping address is duplicated to generate the simplified shipping address.

In addition, to achieve the above object, according to an embodiment of the present disclosure, a terminal for supporting delivery service includes a output unit that displays a simplified shipping address for a shipping address of shipping data and a user interface for modifying the simplified shipping address.

In addition, to achieve the above object, according to an embodiment of the present disclosure, a method for supporting delivery service using a system for supporting delivery service includes generating a minimum unit shipping address in which a shipping address of shipping data is simplified, determining whether the generated minimum unit shipping address is duplicated to generate the simplified shipping address, and generating output data for outputting the generated simplified shipping address.

To achieve the above object, according to an embodiment of the present disclosure, a program stored in a computer-readable recording medium may include a program code for executing the method for supporting delivery service described above.

### Advantageous Effects

Since a delivery person is in charge of an administrative Dong of a region belonging to a business office, it is generally very high level of understanding of buildings, apartments, road names, land-lot numbers, etc., located in the corresponding region. According to the present disclosure, a simplified minimum unit shipping address is generated into a form that the delivery person may identify by considering the understanding of the delivery person, and a simplified shipping address is generated by determining whether the generated minimum unit shipping address is duplicated, thereby generating the simplified shipping address with optimal identification from the perspective of the delivery person.

In addition, according to various embodiments of the present disclosure, since the amount of information displayed is small compared to Related Patent Document 1 showing an abbreviated address including a representative name and a detailed address, it is possible to effectively utilize a limited size of a waybill area and increase the identification of a delivery person.

In addition, according to various embodiments of the present disclosure, by proposing a method for generating output data for outputting the simplified shipping address, it is possible to provide optimal readability to delivery people.

In addition, according to various embodiments of the present disclosure, it is possible to propose a systematic method for generating a simplified shipping address that may be universally applied to delivery people.

### BRIEF DESCRIPTION OF THE DRAWINGS

FIGS. 1A and 1B are an example of a conventional method for identifying a shipping address.

FIG. 2 is a conceptual diagram illustrating a system for supporting delivery service according to an embodiment of the present disclosure.

FIG. 3 is a block diagram illustrating a server for supporting delivery service according to an embodiment of the present disclosure.

FIG. 4 is a block diagram illustrating a terminal for supporting delivery service according to an embodiment of the present disclosure.

FIG. 5 is a flowchart schematically illustrating a method for generating a simplified shipping address according to an embodiment of the present disclosure.

FIG. 6 is a flowchart specifically illustrating a method for generating a simplified shipping address when building specific information is not included according to an embodiment of the present disclosure.

FIG. 7 is a flowchart specifically illustrating a method for generating a simplified shipping address when the building specific information is included according to an embodiment of the present disclosure.

FIGS. 8, 9A, 9B, and 10 are diagrams illustrating a shipping address list for describing a process of generating a simplified shipping address according to an embodiment of the present disclosure.

FIG. 11 is a flowchart illustrating a method for generating output data according to an embodiment of the present disclosure.

FIGS. 12A to 12D are a diagram illustrating an example of highlight processing of a simplified shipping address according to an embodiment of the present disclosure.

FIG. 13 is a timing diagram illustrating a printing processing process of a system for supporting delivery service according to an embodiment of the present disclosure.

FIG. 14 is a diagram illustrating a waybill according to an embodiment of the present disclosure.

FIG. 15 is a timing diagram illustrating a process of modifying the simplified shipping address of a system for supporting delivery service according to an embodiment of the present disclosure.

FIG. 16 is a diagram illustrating a user interface for displaying the simplified shipping address according to an embodiment of the present disclosure.

FIG. 17 is a diagram illustrating the user interface for modifying the simplified shipping address according to an embodiment of the present disclosure.

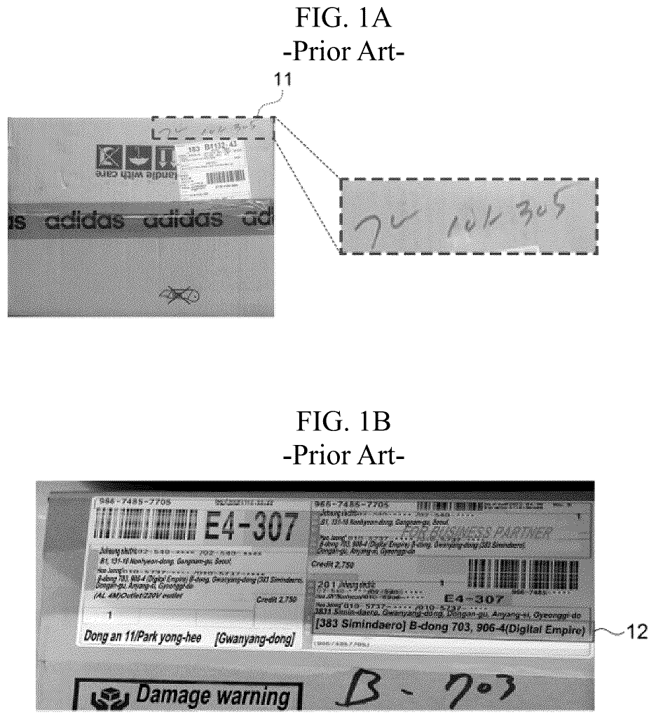

### BEST MODE

Hereinafter, various exemplary embodiments of the present disclosure will be described in detail with reference to the accompanying drawings.

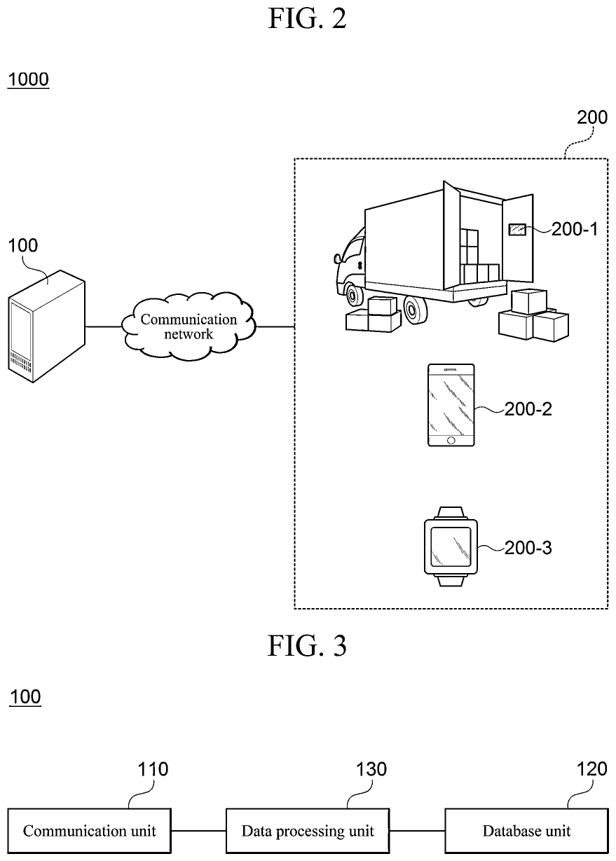

FIG. 2 is a conceptual diagram illustrating a system for supporting delivery service according to an embodiment of the present disclosure. A system 1000 for supporting delivery service is a system that supports delivery service of a delivery person and may include a server 100 for supporting delivery service and a terminal 200 for supporting delivery service.

The server 100 for supporting delivery service may perform storage, management, and/or processing of various data for supporting delivery service of a delivery person.

Specifically, the server 100 for supporting delivery service may perform storage, management, and/or processing of shipping data for a delivery product. Here, the shipping data may include basic shipping information, a delivery product image, shipping identification information, a delivery region code, and delivery person information.

In addition, the server 100 for supporting delivery service may perform storage, management, and/or processing of a simplified shipping address for simplifying a shipping address. Here, the simplified shipping address may be generated by generating a minimum unit shipping address, in which a shipping address among various pieces of information constituting shipping data into a form that may be identified by the delivery person, is simplified, and determining whether the generated minimum unit shipping address is duplicated. In this case, the server 100 for supporting delivery service may construct training data and train a generation model to enhance a generation model that generates the simplified shipping address.

In addition, the server 100 for supporting delivery service may provide a function that allows a user (e.g., control personnel) of the server 100 for supporting delivery service to control delivery situations such as a location of a delivery vehicle, a shipment status, and a delivery completion status in real time based on at least one of data pre-stored in the server and data acquired from the terminal 200 for supporting delivery service.

Here, the server 100 for supporting delivery service may be equipped and operated by a company that operates the delivery service.

Meanwhile, the terminal 200 for supporting delivery service is a terminal device equipped, installed, or held by the delivery person performing the delivery service, and may receive various data for supporting the delivery service from server 100 for supporting delivery service, and output various information for supporting the work of the delivery person according to various conditions such as the location, time, and work environment of the delivery person using the received data. For example, the terminal 200 for supporting delivery service may display a user interface for guidance, search, and modification of the simplified shipping address.

Here, the terminal 200 for supporting delivery service may include a delivery vehicle terminal 200-1 installed in a delivery vehicle driven by the delivery person, a mobile terminal 200-2 that may be carried by the delivery person, a wearable terminal 200-3 that may be worn on the body of the delivery person, etc. For example, the mobile terminal 200-2 may be implemented as a smart phone, a tablet computer, a laptop computer, etc. In addition, the wearable terminal 200-3 may be implemented as a smart watch, smart glasses, etc.

FIG. 3 is a block diagram illustrating a server for supporting delivery service according to an embodiment of the present disclosure. Referring to FIG. 3, the server 100 for supporting delivery service may include all or part of a communication unit 110, a database unit 120, and a data processing unit 130.

The communication unit 110 may perform a communication function for the server 100 for supporting delivery service. Specifically, the communication unit 110 may support a data transmission and reception function between the server 100 for supporting delivery service and the terminal 200 for supporting delivery service.

The database unit 120 may store various programs and data required for the function of the server 100 for supporting delivery service. In particular, the database unit 120 may store various data processed by the data processing unit 130.

The data processing unit 130 may perform various data processing functions for the operation of the server 100 for supporting delivery service. In particular, the data processing unit 130 generates a minimum unit shipping address in which the shipping address of the shipping data stored in the database unit 120 is simplified into the form that may be identified by the delivery person, and determine whether the generated minimum unit shipping address is duplicated to generate a simplified shipping address.

In addition, the data processing unit 130 may generate output data for outputting the generated simplified shipping address. Specifically, the data processing unit 130 may generate output data that emphasizes at least one of the shape, size, and color of the characters that constitutes the simplified shipping address.

Meanwhile, in FIG. 3, it has been described as an example that the server 100 for supporting delivery service includes the database unit 120, but it is not limited thereto. According to another implementation example of the present disclosure, the database unit 120 may be managed by a company (e.g., a logistics company) that manages shipping data for all delivery products, and the server 100 for supporting delivery service may be implemented to access a database that performs a master database function and download and use various data from the database.

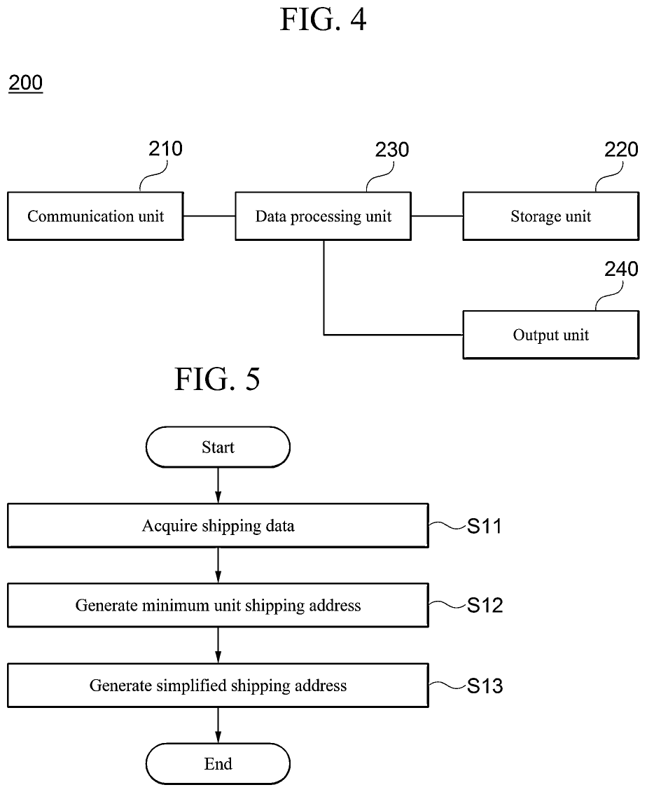

FIG. 4 is a block diagram illustrating a terminal for supporting delivery service according to an embodiment of the present disclosure. Referring to FIG. 4, the terminal 200 for supporting delivery service includes all or part of a communication unit 210, a storage unit 220, a data processing unit 230, and an output unit 240.

The communication unit 210 may perform a communication function for the terminal 200 for supporting delivery service. Specifically, the communication unit 210 may support a data transmission and reception function between the server 100 for supporting delivery service and the terminal 200 for supporting delivery service.

The storage unit 220 may store various programs and data necessary for the function of the terminal 200 for supporting delivery service. In particular, the “program for executing the method for supporting delivery service in the terminal 200” according to the present disclosure may be installed and stored in the storage unit 220.

The data processing unit 230 may perform various data processing functions for the operation of the terminal 200 for supporting delivery service. Specifically, the data processing unit 230 may perform all or part of the functions of the data processing unit 130 of the server 100 for supporting delivery service so that all or part of the functions of the data processing unit 130 of the server 100 for supporting delivery service are performed in the terminal 200 for supporting delivery service. For example, the data processing unit 230 may generate the simplified shipping address from the shipping address of the shipping data, or may generate the output data from the simplified shipping address.

Meanwhile, the output unit 240 may display various user interfaces based on the processing results of the data processing unit 230. For example, the output unit 240 may display a user interface for guidance, search, modification, etc., of the simplified shipping address.

Hereinafter, with reference to the drawings, the operations of the server 100 for supporting delivery service and the terminal 200 for supporting delivery service according to an embodiment of the present disclosure will be described in more detail.

FIG. 5 is a flowchart schematically illustrating a method for generating a simplified shipping address according to an embodiment of the present disclosure. Referring to FIG. 5, first, data processing units 130 and 230 may acquire shipping data (S11). Here, the shipping data may include basic shipping information, a delivery product image, shipping identification information, a delivery region code, and delivery person information.

The basic shipping information may include recipient's address/name/contact information and sender's address/name/contact information. The recipient's address may be called a shipping destination or shipping address, and is collectively referred to as “shipping address” in this specification.

In addition, the delivery product image may contain multiple videos generated by capturing while changing the capturing conditions of the delivery product. Here, the capturing conditions may be a capturing direction, a distance, a field of view (FOV), etc.

That is, during at least one of the cargo collecting processing, truck loading, truck unloading, and loading onto delivery vehicles, the delivery product may be captured by a camera, and the delivery product image may include multiple videos captured under different capturing conditions during various processes.

In addition, the shipping identification information is information that integrates the basic shipping information to enable identification, and may include at least one of a waybill number, a barcode, and a QR code.

In addition, the delivery region code may be a code value that codes and classifies a delivery region to which the shipping address belongs.

In addition, the delivery person information may include a name, contact information, etc., of the delivery person who delivers the delivery product.

Meanwhile, the data processing units 130 and 230 may generate a minimum unit shipping address in which the shipping address of the shipping data is simplified into a form that can be identified by the delivery person (S12). In this case, the data processing units 130 and 230 may generate the minimum unit shipping address in different ways depending on whether the shipping address includes building specific information. Here, the building specific information may include at least one of building dong information, building floor information, and building unit number information.

Specifically, when the shipping address does not include building specific information, the data processing units 130 and 230 determine whether the shipping address is a road name address or a land-lot number address, when the shipping address is a road name address, the data processing units 130 and 230 generate the minimum unit shipping address based on the road name and building number, and when the shipping address is a land-lot number address, the data processing units 130 and 230 generate the minimum unit shipping address based on a name of an administrative Dong or a name of an administrative Ri and a land-lot number.

In addition, when the shipping address includes the building specific information, the minimum unit shipping address may be generated based on the building name and building specific information of the shipping address.

Table 1 below is a table showing the configuration of the shipping address of the land-lot number address system of Korea, and Table 2 below is a table showing the configuration of the shipping address of the road name address system of Korea.

TABLE 1

| Metropolitan local | Basic local | | | | Address | |
|---|---|---|---|---|---|---|
| government | government | Si/gun/gu | Eup/myeon | Dong/Ri | number | Detailed address |
| Seoul | Gangnam-gu | | | Samsung-dong | 338-3 | ∘ ∘ |
| | | | | | | Building A-ho |
| Gyeonggi-do | Suwon-si | Jangan-gu | | Jeongja-dong | 687 | ∘ ∘ |
| | | | | | | Apartment A-dong B-ho |
| Gyeongsa ngnam-do | Changwon-si | Uichang-gu | Daesan-myeon | Gasul-ri | 323-4 | |
| Jeju Special Self- | | Seogwipo-si | Seongsan-eup | Seongsan-ri | 160 | |
| Governing Province | | | | | | |
| Sejong Special Self- | | | Jochiwon-eup, | Sinheung-ri | 24-3 | |
| Governing City | | | | | | |

TABLE 2

| Metropolitan local | Basic local | | | | | Detailed | |
|---|---|---|---|---|---|---|---|
| government | government | Si/gun/gu | Eup/myeon | Road name | Building number | address | References |
| Seoul | Gangnam-gu | | | Southern ring road | Underground 2744 | | (Dog ok-dong) |
| Daegu Metropolitan | Dalseong-gun | | Hyeon pung-myeon | Bisul-ro 134-gil | 157 | | |
| City | | | | | | | |
| Gyeongsangbuk-do | Mungyeong-si | | | Maebong 4-gil | 12 | | Mojeon-dong |
| Jeju Special Self- | | Seogwipo-si | Seongsan-eup | Gosung-dongseo-ro | 10 | Ga-dong 104 | Dong myeong |
| Governing Province | | | | 56beon-gil | | | Apartment |
| Gyeonggi-do | Suwon-si | Yeongtong-gu | | Yeongtong-ro | 124 | | Mangpo-dong |

Meanwhile, the minimum unit shipping address generated in the above-described generating step (S12) may include at least one character corresponding to the identifier of the shipping address. In this case, a character may be a concept including all letters such as Korean or English, numbers, and special characters such as symbols. In addition, all the continuous numbers may be determined as one character. Accordingly, the data processing units 130 and 230 may extract the entire number by treating all the continuous numbers as one character in the extraction process for generating the minimum unit shipping address and the simplified shipping address.

Here, the identifier of the shipping address may be a component that enables identification among multiple shipping addresses among the components, such as the ‘combination of road name and building number’, ‘combination of administrative Dong name or administrative Ri name and a land-lot number’, and ‘combination of building name and building specific information’ described above.

In addition, a non-identifier of the shipping address may be the remaining components except for the identifier of the shipping address described above.

In addition, the non-identifier of the shipping address may include characters that are not related to the identification of the shipping address, such as characters ‘ro’ or ‘gil’ referring to a road included in a road name, characters ‘Dong’ or ‘Ri’ referring to Dong or Ri included in an administrative Dong or administrative Ri, and characters ‘technotown’, ‘apartment’, ‘knowledge industry center’, ‘town’, or ‘building’, ‘villa’, ‘officetel’, ‘tower that specify a type or use of a building included in a building name.

For example, when the shipping address is “1010-ho, 15th Daeryung Techno Town, Gwanyang-dong, Dongan-gu, Anyang-si, Gyeonggi-do”, the data processing units 130 and 230 may generate a minimum unit shipping address that includes at least one character for the identifiers of the shipping address, ‘Daeryung’, ‘15th’, and ‘1010-ho’.

Meanwhile, the data processing units 130 and 230 may determine whether the generated minimum unit shipping address is duplicated to generate the simplified shipping address (S13). Specifically, when the generated minimum unit shipping address is not duplicated, the data processing unit 130 and 230 may generate the generated minimum unit shipping address as the simplified shipping address. In addition, when the generated minimum unit shipping address is duplicated, the data processing units 130 and 230 may generate the simplified shipping address that further includes predetermined information in the minimum unit shipping address to distinguish between the duplicated minimum unit shipping addresses. Here, the predetermined information may include at least one character to distinguish between the duplicated minimum unit shipping addresses.

In this case, in order to prevent the duplicated simplified shipping address in the work area of the delivery person, the data processing unit 130 and 230 may check whether the generated minimum unit shipping address is duplicated in the above-described generating step (S12) within the shipping addresses classified based on the predetermined unit.

Here, the predetermined unit for checking the duplication of the minimum unit shipping address may be at least one of a delivery person unit, a region unit including multiple delivery people, a business office unit including multiple regions, and an administrative district unit including multiple business offices.

For example, when the predetermined unit is set as the delivery person unit, the data processing units 130 and 230 may check the duplication of the simplified shipping addresses of delivery products assigned to the delivery person.

Meanwhile, preferably, considering the characteristics of the delivery industry in which the business area of the delivery person is divided into business office units, the data processing units 130 and 230 may determine the criterion of the duplication check unit as at least one of the delivery person unit, the region unit including multiple delivery people, and the business office unit including multiple regions.

Meanwhile, the data processing units 130 and 230 may add a delimiter to distinguish between different types of identifiers included in at least one of the generated minimum unit shipping address and the simplified shipping address. For example, the data processing units 130 and 230 may add the delimiter based on the rules of \textcircled{1} to \textcircled{3} below. Here, the delimiter may be composed of symbols such as ‘-’, ‘*’, or spaces.
\textcircled{1} Different types of identifiers have delimiters.
\textcircled{2} Exceptionally, i) all identifiers extracted from each of the road name and

serial number are treated as a single set and thus delimiters are not added, and ii) all identifiers extracted from each of the road name, serial number, and branch road name are treated as a single set and thus delimiters are not added.
\textcircled{3} When numbers, which are different types of identifiers, are arranged in a row, a delimiter different from the delimiter used in \textcircled{1} is added between the identifiers.

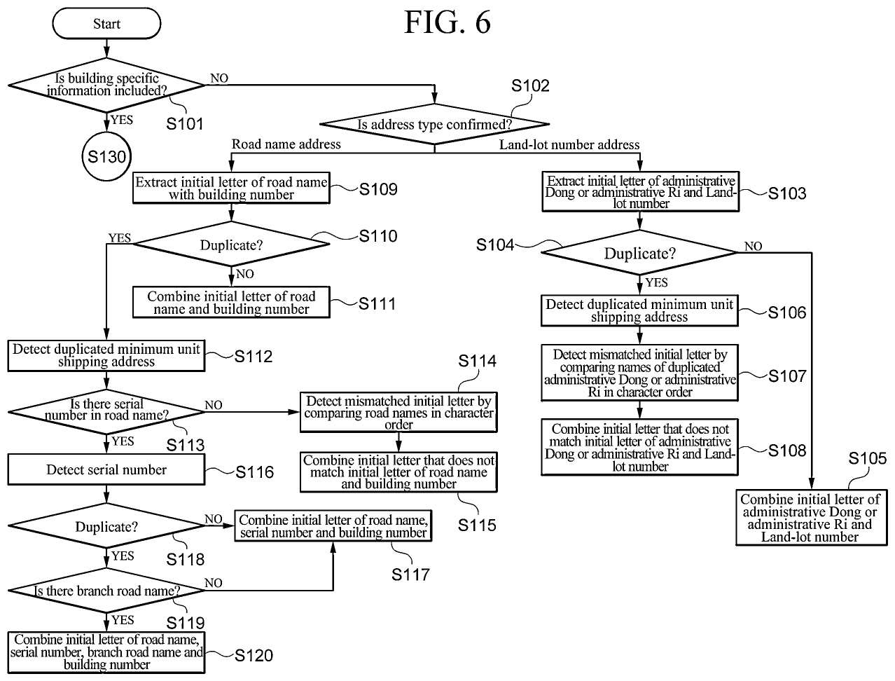

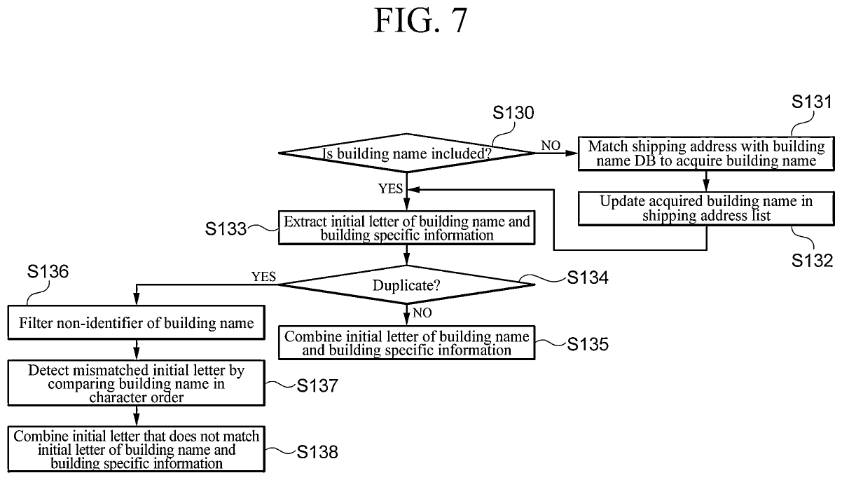

Hereinafter, the generation of the minimum unit shipping address (S12) and the generation of the simplified shipping address (S13) will be described in more detail with reference to FIGS. 6 and 7.

FIG. 6 is a flowchart specifically illustrating a method for generating a simplified shipping address when building specific information is not included according to an embodiment of the present disclosure. Referring to FIG. 6, the data processing units 130 and 230 may determine whether the building specific information is included in the shipping address acquired from shipping data (S101). Here, the building specific information may include at least one of building dong information, building floor information, and building unit number information.

When there is no building specific information (S101: NO), the data processing units 130 and 230 may determine the address type, whether the shipping address is a road name address or a land-lot number address (S102).

When the shipping address is the land-lot number address (S102: a land-lot number address), the data processing units 130 and 230 may extract the initial letter of the name of the administrative Dong or the name of the administrative Ri and the land-lot number to generate the minimum unit shipping address (S103).

The data processing units 130 and 230 may determine whether the generated minimum unit shipping address is duplicated (S104).

When it is determined that there is no duplication (S104: NO), the data processing units 130 and 230 may generate the minimum unit shipping address generated in step S103 as the simplified shipping address (S105). That is, the data processing units 130 and 230 may generate the simplified shipping address composed of a combination of the initial letter of the name of the administrative Dong or the name of the administrative Ri and the land-lot number.

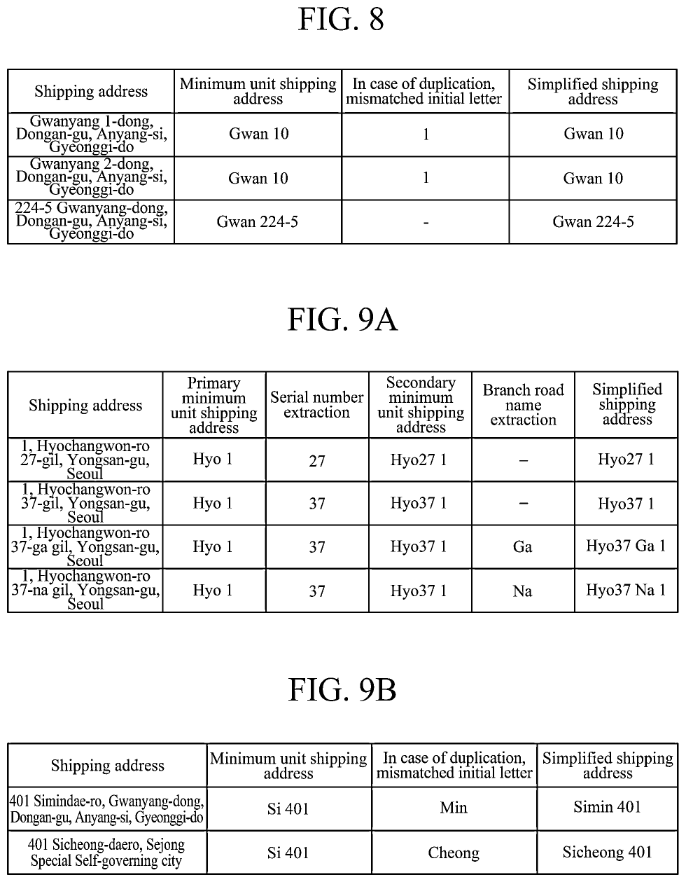

FIG. 8 is an example of a shipping address list. Referring to FIG. 8, the data processing units 130 and 230 may extract an initial letter of a name of an administrative Dong and a land-lot number from a shipping address ‘224-5 Gwanyang-dong, Dongan-gu, Anyang-si, Gyeonggi-do’ to generate ‘Gwan 224-5’ as a minimum unit shipping address, and since there is no minimum unit shipping address duplicating ‘Gwan 224-5’ in the shipping address list, the minimum unit shipping address ‘Gwan 224-5’ may be generated as a simplified shipping address.

However, if it is determined to be a duplicate (S104: YES), the data processing units 130 and 230 may detect the duplicated minimum unit shipping address (S106), and compare the name of the administrative Dong or the name of the administrative Ri corresponding to the duplicated minimum unit shipping address in character order to detect the mismatched initial letter (S107).

The data processing units 130 and 230 may generate the simplified shipping address that further includes the initial letter that does not match the minimum unit shipping address. That is, the data processing units 130 and 230 may generate a simplified shipping address composed of a combination of an initial letter that does not match an initial letter of the name of the administrative Dong or the name of the administrative Ri and a land-lot number.

For example, referring to FIG. 8, the data processing units 130 and 230 may extract an initial letter of a name of an administrative Dong and a land-lot number from a shipping address ‘10 Gwanyang 1-dong, Dongan-gu, Anyang-si, Gyeonggi-do’ to generate a minimum unit shipping address ‘Gwan 10’, and extract an initial letter of a name of an administrative Dong and a land-lot number from a shipping address ‘10 Gwanyang 2-dong, Dongan-gu, Anyang-si, Gyeonggi-do’ to generate a minimum unit shipping address ‘Gwan 10’. In this case, since the generated minimum unit shipping address is duplicated as ‘Gwan 10’, the data processing units 130 and 230 compare the names of the administrative Dong corresponding to the minimum unit shipping address, ‘Gwanyang 1-dong’ and ‘Gwanyang 2-dong’, in character order to detect the mismatched initial letters ‘1’ and ‘2’, and combine the mismatched initial letters in the minimum unit shipping address at the detected positions to generate ‘Gwan1 10’ and ‘Gwan2 10’ as the simplified shipping addresses, respectively.

Meanwhile, when the shipping address is the road name address (S102), the data processing units 130 and 230 may extract the initial letter of the road name and the building number to generate the minimum unit shipping address (S109).

The data processing units 130 and 230 may determine whether the generated minimum unit shipping address is duplicated (S110). For example, the data processing units 130 and 230 may determine whether there is a duplicate by comparing with the minimum unit shipping address already generated in the above-described duplicate check unit.

When it is determined that there is no duplication (S110: NO), the data processing units 130 and 230 may generate the minimum unit shipping address generated in step S109 as the simplified shipping address (S111). In other words, the data processing units 130 and 230 may generate the simplified shipping address composed of a combination of the initial letter of the road name and the building number.

FIGS. 9A and 9B are an example of a shipping address list. Referring to FIG. 9A, the data processing units 130 and 230 may extract an initial letter of a road name and a building number from a shipping address ‘27, Hyochangwon-ro, Yongsan-gu, Seoul’ to generate a minimum unit shipping address ‘Hyo27’, and since there is no minimum unit shipping address duplicating ‘Hyo27’ in the shipping address list, the minimum unit shipping address ‘Hyo27’ may be generated as the simplified shipping address.

However, when it is determined to be a duplicate (S110: YES), the data processing units 130 and 230 may detect the duplicated minimum unit shipping address (S112) and determine whether there is a serial number in the road name corresponding to the duplicated minimum unit shipping address (S113).

When there is no serial number in the road name corresponding to the duplicated minimum unit shipping address (S113: NO), the data processing units 130 and 230 may detect a mismatched initial letter by comparing the road name in character order (S114). The data processing units 130 and 230 may generate the simplified shipping address that further includes the initial letter that does not match the minimum unit shipping address (S115). In other words, the data processing units 130 and 230 may generate a simplified shipping address that is composed of a combination of an initial letter that does not match a initial letter of the road name and a building number.

For example, referring to FIG. 9B, the data processing units 130 and 230 may generate a minimum unit shipping address ‘Si 401’ by extracting an initial letter of the road name and a building number from a shipping address ‘401 Simindaero, Gwanyang-dong, Dongan-gu, Anyang-si, Gyeonggi-do’, and may generate ‘Si 401’ from a shipping address ‘401 Sicheong-daero, Sejong Special Self-Governing City’. In this case, since the generated minimum unit shipping address is duplicated as ‘Si 401’, the data processing units 130 and 230 may determine whether the road name corresponding to the minimum unit shipping address has a serial number. In addition, since the serial number does not exist, the data processing units 130 and 230 compare ‘Simindaero’ and ‘Sicheong-daero’ in character order to detect the mismatched initial letters ‘Min’ and ‘Cheong’, and combine the mismatched initial letters in the minimum unit shipping address at the detected position to generate ‘Simin 401’ and Sicheong 401’ as a simplified shipping addresses, respectively.

Meanwhile, when there is a serial number in the road name corresponding to the duplicated minimum unit shipping address (S113: YES), the data processing units 130 and 230 may detect the serial number from the road name and determine whether the minimum unit shipping address including the serial number is duplicated (S118).

When it is determined that there is no duplicate (S118: NO), the data processing units 130 and 230 may generate a simplified shipping address composed of a combination of an initial letter of a road name, a serial number, and a building number (S117).

For example, referring to FIG. 9A, the data processing units 130 and 230 may extract an initial letter of a road name and a building number from a shipping address ‘1, Hyochangwon-ro 27-gil, Yongsan-gu, Seoul’ and generate a primary minimum unit shipping address ‘Hyo 1’. In this case, since the generated primary minimum unit shipping address duplicates another first minimum unit shipping address in the shipping address list, the data processing units 130 and 230 may determine whether the road name corresponding to the minimum unit shipping address has a serial number, and combine the serial number ‘27’ in the position of the serial number in the primary minimum unit shipping address to generate a secondary minimum unit shipping address ‘Hyo27 1’. In addition, since the secondary minimum unit shipping address ‘Hyo27 1’ does not duplicate another secondary minimum unit shipping address in the shipping address list, the data processing units 130 and 230 may generate ‘Hyo27 1’ as a simplified shipping address.

That is, the data processing units 130 and 230 may generate the minimum unit shipping address and the simplified shipping address by positioning the road name, the serial number, and the building number respectively, so that they are combined in the order of the initial letter of the road name, the serial number, and the building number. In addition, the data processing units 130 and 230 may use a different delimiter from that used basically between the serial number and the building number where numbers are arranged consecutively.

Meanwhile, when it is determined to be a duplication (S118: YES), the data processing units 130 and 230 may determine whether a branch road name exists (S119). When it is determined that there is no branch road name (S119: NO), the data processing units 130 and 230 may generate a simplified shipping address composed of a combination of an initial letter of a road name, a serial number, and a building number (S117). For example, referring to FIG. 9A, the data processing units 130 and 230 may extract an initial letter of a road name and a building number from a shipping address ‘1, Hyochangwon-ro 37-gil, Yongsan-gu, Seoul’ and generate a primary minimum unit shipping address ‘Hyo 1’. In this case, since the generated primary minimum unit shipping address duplicates another first minimum unit shipping address in the shipping address list, the data processing units 130 and 230 may determine whether the road name corresponding to the minimum unit shipping address has a serial number, and combine the serial number ‘37’ in the position of the serial number in the primary minimum unit shipping address to generate a secondary minimum unit shipping address ‘Hyo37 1’. In addition, since the generated secondary minimum unit shipping address duplicates another secondary minimum unit shipping address in the shipping address list, the data processing units 130 and 230 may determine whether the branch road name exists in the road name, and since there is no branch road name, may generate ‘Hyo37 1’ as a simplified shipping address.

Meanwhile, when there is the branch road name (S119: YES), the data processing units 130 and 230 may generate a simplified shipping address composed of a combination of an initial letter of a road name, a serial number, a branch road name, and a building number (S120). For example, referring to FIG. 9A, the data processing units 130 and 230 may generate the primary minimum unit shipping address ‘Hyo 1’ by extracting the initial letter of the road name and the building number from the shipping addresses ‘1, Hyochangwon-ro 37ga-gil, Yongsan-gu, Seoul’ and ‘1, Hyochangwon-ro 37na-gil, Yongsan-gu, Seoul’, respectively. In this case, since the generated primary minimum unit shipping address duplicates another first minimum unit shipping address in the shipping address list, the data processing units 130 and 230 may determine whether the road name corresponding to the minimum unit shipping address has a serial number, and combine the serial number ‘37’ in the position of the serial number in the primary minimum unit shipping address to generate a secondary minimum unit shipping address ‘Hyo37 1’. In addition, since the generated secondary minimum unit shipping address duplicates another secondary minimum unit shipping addresses in the shipping address list, the data processing units 130 and 230 may determine whether there is the branch road name in the road name, and combine the branch road names ‘Ga’ and ‘Na’ in the branch road name position in the secondary minimum unit shipping address to generate simplified shipping addresses, such as ‘Hyo37Ga 1’ and ‘Hyo37Na 1’.

That is, the data processing units 130 and 230 may generate the minimum unit shipping address and the simplified shipping address by positioning the road name, the serial number, the branch road name, and the building number respectively, so that they are combined in the order of the initial letter of the road name, the serial number, the branch road name, and the building number.

Meanwhile, when the shipping address includes the building specific information (S101: Y), the data processing units 130 and 230 may proceed to step S130. This will be described in more detail with reference to FIG. 7. This will be described in more detail with reference to FIG. 7.

FIG. 7 is a flowchart illustrating in detail the method for generating a simplified shipping address when the building specific information is included according to an embodiment of the present disclosure. Referring to FIG. 7, the data processing units 130 and 230 may determine whether the shipping address includes the building name (S130). When the shipping address does not include the building name (S130: NO), the data processing units 130 and 230 may match the shipping address to a building name database to acquire the building name corresponding to the shipping address (S131) and update the acquired building name to the shipping address list (S132).

Meanwhile, when the shipping address includes the building name (S130: YES) or the building name is acquired from the building name database, the data processing units 130 and 230 may extract the initial letter of the building name and at least of the building dong information, the building floor information, and the building unit number information constituting the building specific information to generate a minimum unit shipping address (S133), and may determine whether the generated minimum unit shipping address is duplicated (S134).

When it is determined that the generated minimum unit shipping address is not duplicated (S134: NO), the data processing units 130 and 230 may generate the generated minimum unit shipping address as the simplified shipping address (S135). That is, the data processing units 130 and 230 may generate the simplified shipping address composed of a combination of the initial letter of the building name and at least one of the building dong information, the building floor information, and the building unit number information constituting the building specific information (S135).

However, when the minimum unit shipping address is determined to be duplicated (S134: YES), the data processing units 130 and 230 may filter out the non-identifiers of the building name corresponding to the minimum unit shipping address (S136) and compare the building name corresponding to the minimum unit shipping address in character order to detect the mismatched initial letter (S137). The data processing units 130 and 230 may generate the simplified shipping address by combining the minimum unit shipping address with the mismatched initial letter (S138). That is, the data processing units 130 and 230 may generate the simplified shipping address composed of a combination of the initial letter that does not match the initial letter of the building name and at least one of the building dong information, the building floor information, and the building unit number information constituting the building specific information (S138).

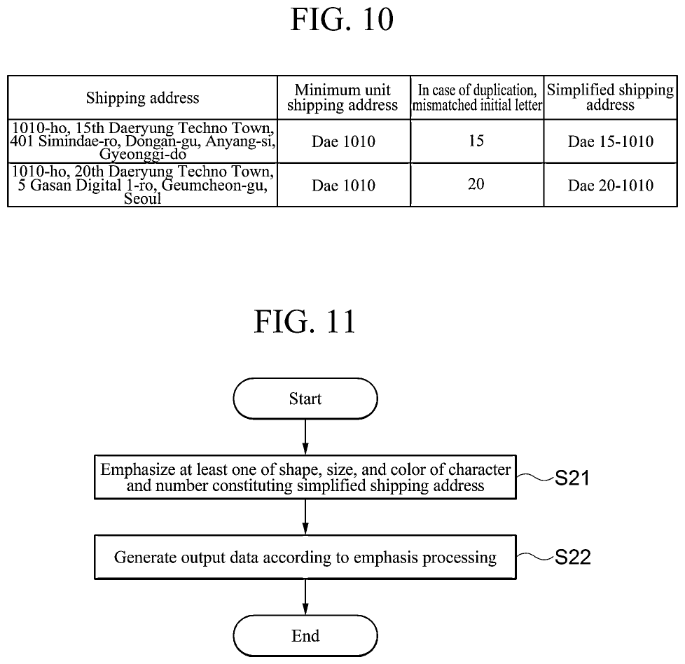

FIG. 10 is an example of a shipping address list. Referring to FIG. 10, the data processing units 130 and 230 may extract the initial letter ‘Dae’ of the building name and the building unit number information ‘1010’ from a shipping address ‘1010-ho, 15th Daeryung Techno Town, 401 Simindaero, Dongan-gu, Anyang-si, Gyeonggi-do’ and a shipping address ‘1010-ho, 20th Daeryung Techno Town, 5 Gasan Digital 1-ro, Geumcheon-gu, Seoul’, respectively, and generate ‘Dae 1010’ as the minimum unit shipping address. In this case, since the generated minimum unit shipping address is duplicated, the data processing units 130 and 230 filter out the non-identifier ‘Technotown’ of the building name corresponding to the minimum unit shipping address, compare ‘Daeryung 15th’ and ‘Daeryung 20th’ in character order, detect the mismatched initial letters ‘15’ and ‘20’, and combine the mismatched initial letters in the minimum unit shipping address at the detection position to generate ‘Dae15-1010’ and ‘Dae20-1010’ as simplified shipping addresses, respectively.

That is, the data processing units 130 and 230 may generate the minimum unit shipping address and the simplified shipping address by positioning the building name, the mismatched information, and the building specific information, respectively, so that they are combined in the order of the building name, the mismatched information, and the building specific information. In addition, the data processing units 130 and 230 may add a delimiter to distinguish between the two when the mismatched initial letter is composed of numbers and the building specific information is composed numbers, as in the example of FIG. 10.

Meanwhile, steps S104, S110, S118, and S134 for checking for duplication in FIGS. 6 and 7 described above may be performed by comparing the minimum unit shipping addresses that have already been generated in predetermined units for the above-described duplication check.

In general, since the delivery person is in charge of the administrative Dong of the region belonging to the business office for a long period of time and performs the delivery service, the delivery person has a very high level of understanding of the building, the apartment, the road name, the land-lot number, etc., located in the region. Considering the understanding of the delivery person, when the delivery address, minimized in a form that can be identified by the delivery person, is not duplicated by individual delivery person, region, or business office, the simplified shipping address may be information with optimal identification and high readability from the delivery person's perspective.

This kind of duplication check of simplified delivery information may be subdivided into a delivery person's responsibility area (for example, district 1 in Gwanyang-dong districts 1 and 2), or expanded to apply to the same region in the administrative district (for example, the entire Gwanyang-dong or the entire Dongan-gu district), a business office responsibility area to which the delivery person belongs, etc.

The present disclosure may achieve the above-described effect by generating the minimum unit shipping address that is simplified in the form that may be identified by the delivery person, and determining whether the generated minimum unit shipping address is duplicated to generate the simplified shipping address. In addition, according to the present disclosure, a systematic method for generating a simplified shipping address that may be universally applied to delivery people may be proposed.

FIG. 11 is a flowchart illustrating a method for generating output data according to an embodiment of the present disclosure. Referring to FIG. 11, the data processing units 130 and 230 may emphasize at least one of the shape, size, and color of the characters that constitutes the simplified shipping address (S21).

The data processing units 130 and 230 may generate output data according to the above-described emphasis processing (S22).

Here, the output data generated by the data processing units 130 and 230 may be output data for outputting a waybill with the simplified shipping address emphasized. For example, the data processing units 130 and 230 may generate at least one of output data in which the simplified shipping address is emphasized in the shipping address in the waybill and output data in which the simplified shipping address is displayed separately from the shipping address in the waybill.

In addition, the output data generated by the data processing units 130 and 230 may be output data for outputting the simplified shipping address separately from the waybill. For example, the data processing units 130 and 230 may include output data in a form displayed on one side of the delivery product separately from the waybill. Here, the output data in the form displayed on one side of the delivery product separately from the waybill may include, for example, data for printing the simplified shipping address on paper separate from the waybill, data for printing on the packaging of the delivery product or the delivery product itself.

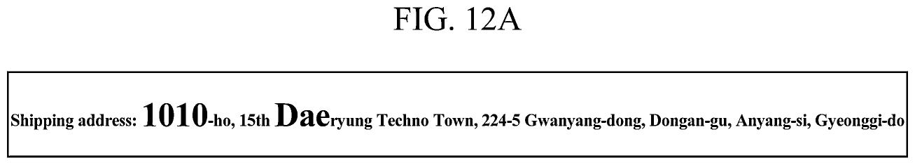

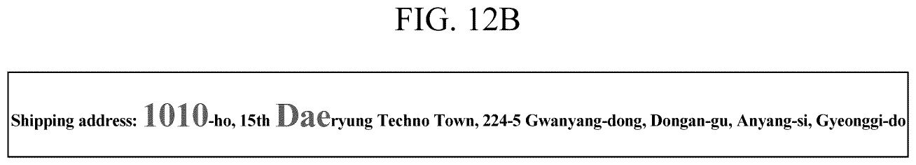

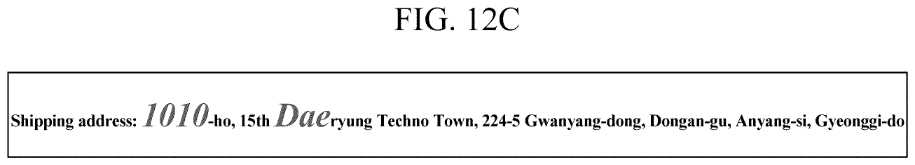

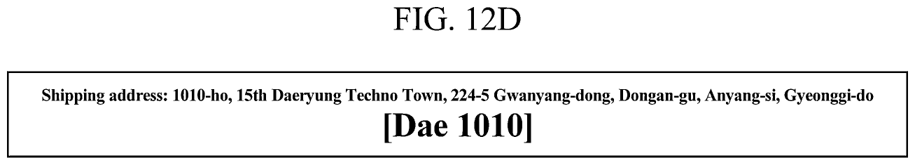

This will be described in more detail with reference to FIGS. 12A to 12D.

FIGS. 12A to 12D are a diagram illustrating an example of emphasis processing of a simplified shipping address according to an embodiment of the present disclosure. FIGS. 12A to 12C illustrate examples of emphasizing a simplified shipping address in a shipping address. The data processing units 130 and 230 may emphasize the size of the letter ‘Dae’ and the number ‘1010’ that constitute the simplified shipping address in the shipping address as in FIG. 12A, emphasize the color as in FIG. 12B, or emphasize the shape (e.g., letter type, italics, underline, background color, etc.) that constitutes the simplified shipping address in the shipping address as in FIG. 12C.

FIG. 12D illustrates an example of emphasizing the simplified shipping address separately from the shipping address, and the data processing units 130 and 230 may emphasize characters that constitute the simplified shipping address separately from the shipping address, as illustrated in FIG. 12D. In addition, in this case, the shape (e.g., letter type, italics, underline, background color, etc.) that constitutes the simplified shipping address in the shipping address may be emphasized.

Meanwhile, the above-described output data may be data in a format that may be printed through a printing device or data in a format that may be displayed through a display device.

According to the present disclosure, by proposing the method of generating output data for printing a simplified shipping address, the optimal readability may be provided to delivery persons.

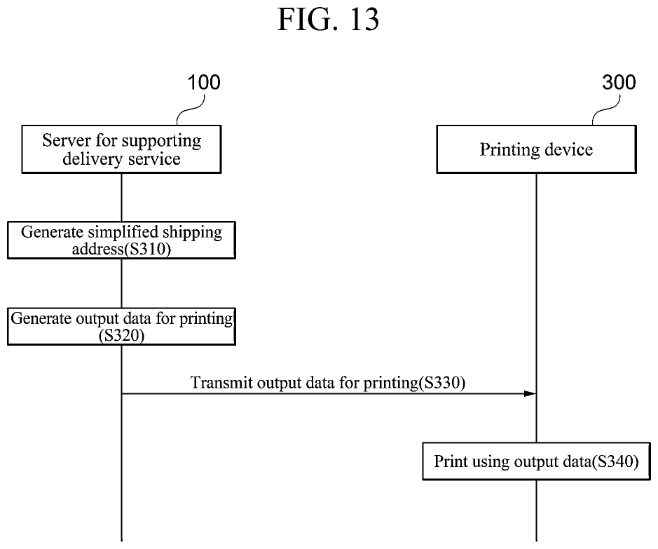

Hereinafter, with reference to FIGS. 13 to 17, the operation of the system 1000 for supporting delivery service using the generated simplified shipping address will be described in more detail. However, in FIGS. 13 to 17, the simplified shipping address is described as being generated in the data processing unit 130 of the server 100 for supporting delivery service, but it is not limited thereto, and the simplified shipping address may be implemented to be generated in the data processing unit 230 of the terminal 200 for supporting delivery service.

FIG. 13 is a timing diagram showing a process of printing a simplified shipping address according to an embodiment of the present disclosure. Referring to FIG. 13, the data processing unit 130 of the server 100 for supporting delivery service may generate the simplified shipping address (S310), and the data processing unit 130 of the server 100 for supporting delivery service may generate output data for printing based on the generated simplified shipping address (S320). Here, the output data for printing may be data in a format that may be printed through the printing device 300.

The communication unit 110 of the server 100 for supporting delivery service may transmit the generated output data for printing to the printing device 300, and the printing device 300 may print a printing paper on which the simplified shipping address is recorded based on the received output data for printing.

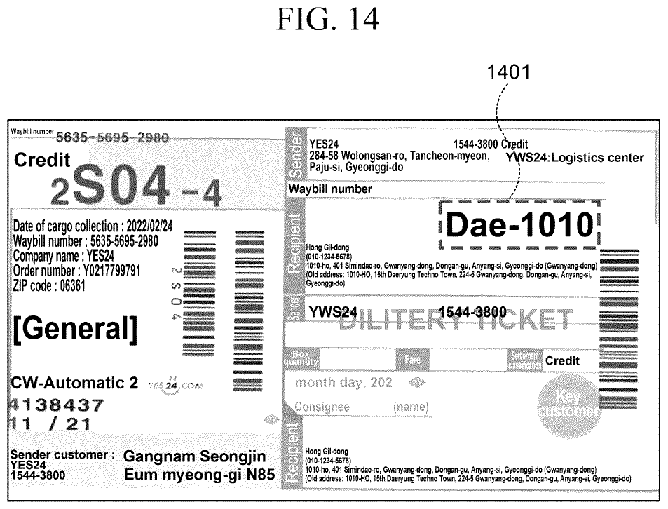

Here, an example of a printed paper printed by the printing device 300 may be a waybill attached to a delivery product. This will be described in more detail with reference to FIG. 14.

FIG. 14 is a diagram illustrating a waybill according to an embodiment of the present disclosure. Referring to FIG. 14, the server 100 for supporting delivery service may generate output data in the form that the simplified shipping address is displayed separately from the shipping address in the waybill, and may transmit the generated output data to the printing device 300. In this case, the printing device 300 may print the waybill in which the simplified shipping address 1401 is emphasized separately from the shipping address.

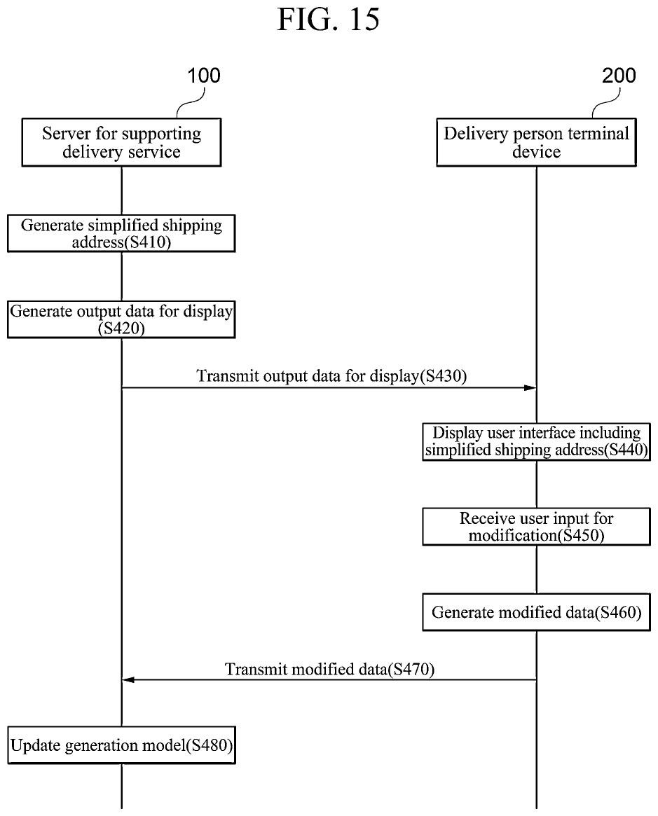

FIG. 15 is a timing diagram showing a process of printing a simplified shipping address according to an embodiment of the present disclosure. Referring to FIG. 15, the data processing unit 130 of the server 100 for supporting delivery service may generate the simplified shipping address (S410), and the data processing unit 130 of the server 100 for supporting delivery service may generate output data for display based on the generated simplified shipping address (S420). Here, the output data for display may be data in a format that may be displayed through the delivery person terminal device (200).

The communication unit 110 of the server 100 for supporting delivery service may transmit the generated output data for display to the delivery person terminal device 200 (S430), and the delivery person terminal device 200 may display a user interface including the simplified shipping address based on the received display output data (S440).

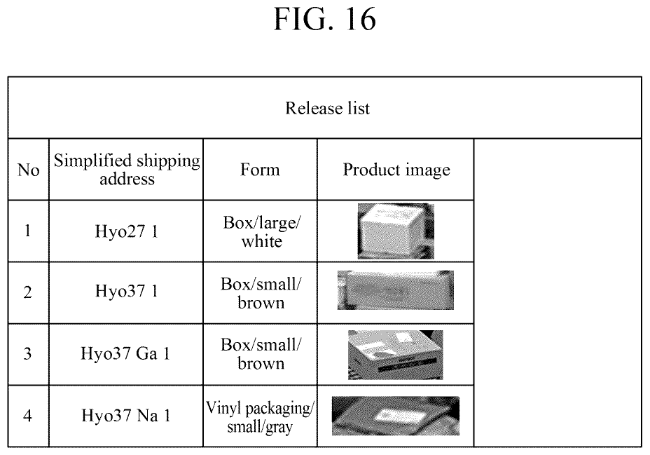

Here, the user interface may include a user interface that displays the simplified shipping address. This will be described in more detail with reference to FIG. 16.

FIG. 16 is a diagram illustrating a user interface for displaying the simplified shipping address according to an embodiment of the present disclosure. Referring to FIG. 16, the terminal 200 for supporting delivery service provides a user interface that matches the form information of the product to be released and the delivery product image to the simplified shipping address, thereby increasing the identification and readability of the delivery person's shipping address and improving delivery convenience.

Meanwhile, although not illustrated in FIG. 16, the user interface may include a search function based on the simplified shipping address. For example, when a search command including the simplified shipping address is input from the delivery person to the terminal 200 for supporting delivery service, the data processing unit 230 of the terminal 200 for supporting delivery service may search for the delivery product image corresponding to the input simplified shipping address. In addition, the output unit 240 of the terminal 200 for supporting delivery service may display the searched delivery product image.

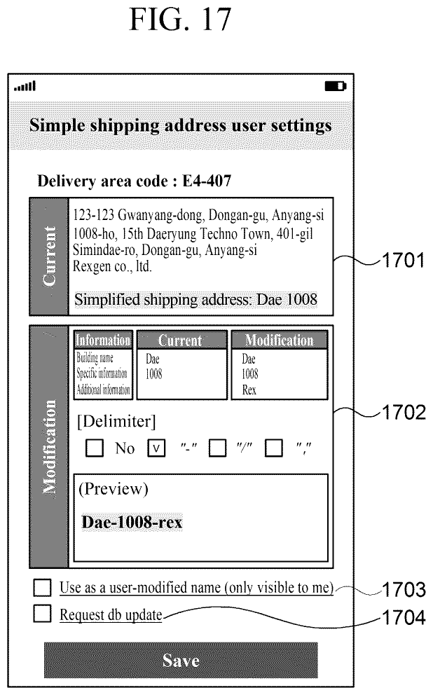

Meanwhile, the delivery person may want to modify the simplified shipping address generated by the data processing units 130 and 230 into the form that is easy for the delivery person to identify. Accordingly, the present disclosure may provide the user interface for modifying the simplified shipping address. This will be described in more detail with reference to FIG. 17.

FIG. 17 is a diagram illustrating the user interface for modifying the simplified shipping address according to an embodiment of the present disclosure. Referring to FIG. 17, the user interface may include a first UI area 1701 for displaying a simplified shipping address generated according to a shipping address and a preset generation model, and a second UI area 1702 for modifying a simplified shipping address.

The delivery person may check a detailed shipping address and a simplified shipping address ‘Dae 1008’ generated according to a preset generation model through the first UI area 1701, and may modify the simplified shipping address in a form that is easy for the person to identify through the second UI area 1702. For example, ‘Dae’ may be extracted from the building name ‘Daeryung Techno Town’, ‘1008’ may be extracted from ‘1008’, ‘Rex’ may be extracted from ‘Rexgen Co., Ltd’, and the simplified shipping address may be modified to use ‘-’ as a delimiter.

Accordingly, the simplified shipping address ‘Dae 1008’ generated according to the preset generation model may be modified to ‘Dae-1008-Rex’ according to the modification of the delivery person.

Meanwhile, the user interface may include a ‘use as user name (only viewable by me) 1703’ selection area for setting the modified simplified shipping address as a simplified shipping address for the delivery person only through the second UI area 1702.

In addition, the user interface may include a ‘request DB update (1704)’ selection area for setting the modified simplified shipping address to be updated to the database unit 120 of the server 100 through the second UI area 1702.

In addition, although not shown in FIG. 17, the user interface may further include a third UI area (not illustrated) for modifying the generation model of the simplified shipping address. Accordingly, the delivery person may modify the generation model for generating the simplified shipping address through the third UI area.

Returning to FIG. 15, when a user input for modifying at least one of the simplified shipping address and the generation model of the simplified shipping address is received through the user interface as described above (S450), the data processing unit 230 of the delivery person terminal device 200 may generate modified data that is modified according to the user input (S460). Then, the communication unit 210 of the delivery person terminal device 200 may transmit the modified data to the server 100 for supporting delivery service (S470).

In this case, the data processing unit 130 of the server 100 for supporting delivery service may update the generation model of the simplified shipping address based on the received modified data (S480).

Here, the generation model of the simplified shipping address may be advanced to generate an optimal simplified shipping address that takes into account the situation of the delivery person in the corresponding region according to the training.

Hereinabove, the present disclosure has been described with reference to exemplary embodiments. All exemplary embodiments and conditional illustrations disclosed in the present disclosure have been described to intend to assist in the understanding of the principle and the concept of the present disclosure by those skilled in the art to which the present disclosure pertains. Therefore, it will be understood by those skilled in the art to which the present disclosure pertains that the present disclosure may be implemented in modified forms without departing from the spirit and scope of the present disclosure.

Therefore, the embodiments disclosed herein should be considered in an illustrative aspect rather than a restrictive aspect. The scope of the present disclosure should be defined by the claims rather than the above description, and equivalents to the claims should be interpreted to fall within the present disclosure.

Meanwhile, the method for supporting delivery service according to various exemplary embodiments of the present disclosure described above may be implemented as programs and be provided to servers or devices. Therefore, the respective devices may access the servers or the devices in which the programs are stored to download the programs.

In addition, the methods according to various exemplary embodiments of the present disclosure described above may be implemented as programs and be provided in a state in which it is stored in various non-transitory computer-readable media. The non-transitory computer readable medium is not a medium that stores data for a while, such as a register, a cache, a memory, or the like, but means a medium that semi-permanently stores data and is readable by an apparatus. In detail, the various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

Although the embodiments of the disclosure have been illustrated and described hereinabove, the disclosure is not limited to the specific embodiments described above, but may be variously modified by those skilled in the art to which the disclosure pertains without departing from the scope and spirit of the disclosure as claimed in the claims. These modifications should also be understood to fall within the technical spirit and scope of the disclosure.

What is claimed is:

1. A server for supporting delivery service, comprising:
a data processing unit that generates a minimum unit shipping address in which a shipping address of shipping data is simplified into a form identifiable by a delivery person, and determines whether the minimum unit shipping address is duplicated to generate the simplified shipping address,
wherein the minimum unit shipping address includes at least one character included in an identifier of the shipping address.

2. The server of claim 1, wherein the data processing unit checks whether the minimum unit shipping address is duplicated within a shipping address classified based on a predetermined unit, and
the predetermined unit includes at least one of a delivery person unit, a region unit including multiple delivery people, a business office unit including multiple regions, and an administrative district unit including multiple business offices.

3. The server of claim 1, wherein the shipping data includes a delivery product image.

4. The server of claim 1, wherein the data processing unit determines whether the shipping address includes building specific information, and
the building specific information includes at least one of building dong information, building floor information, and building unit number information.

5. The server of claim 4, wherein the data processing unit determines whether the shipping address is a road name address or a land-lot number address when there is no building specific information in the shipping address,
extracts an initial letter of an administrative Dong name or administrative Ri name and a land-lot number to generate the minimum unit shipping address when the shipping address is the land-lot number address, and
extracts an initial letter of the road name and a building number to generate the minimum unit shipping address when the shipping address is the road name address.

6. The server of claim 4, wherein the data processing unit determines whether the shipping address includes a building name when there is the building specific information in the shipping address.

7. The server of claim 6, wherein when there is no building name in the shipping address, the data processing unit matches the shipping address to a building name database to acquire the building name corresponding to the shipping address.

8. The server of claim 6, wherein the data processing unit extracts an initial letter of the building name and the building specific information when there is a building name in the shipping address to generate the minimum unit shipping address.

9. The server of claim 5, wherein when the minimum unit shipping address is not duplicated, the minimum unit shipping address is generated as the simplified shipping address, and
when the minimum unit shipping address is duplicated, the simplified shipping address that further includes predetermined information is generated in the minimum unit shipping address.

10. The server of claim 1, wherein the simplified shipping address is data that is modifiable through user input.

11. The server of claim 10, wherein the data processing unit trains a generation model that generates the simplified shipping address based on the data generated according to the user input.

12. The server of claim 1, wherein the data processing unit generates output data for outputting the simplified shipping address.

13. The server of claim 12, wherein the data processing unit generates output data that emphasizes at least one of a shape, size, and color of characters constituting the simplified shipping address.

14. The server of claim 13, wherein the data processing unit generates at least one of output data into a form that the simplified shipping address is emphasized in a shipping address in a waybill, output data into a form that the simplified shipping address is displayed separately from the shipping address in the waybill, and output data into a form that the simplified shipping address is displayed separately from the waybill on one side of a delivery product.

15. A terminal for supporting delivery service, comprising:
a output unit that displays a simplified shipping address in which a shipping address of shipping data is simplified into a form identifiable by a delivery person and a user interface for modifying the simplified shipping address,
wherein the simplified shipping address is generated by determining whether a minimum unit shipping address, in which the shipping address of the shipping data is simplified, is duplicated, and
the minimum unit shipping address includes at least one character included in an identifier of the shipping address.

16. The terminal of claim 15, further comprising:
a data processing unit that generates modified data by allowing the delivery person to modify at least one of the displayed simplified shipping address and a generation model of the simplified shipping address.

17. The terminal of claim 15, wherein when the simplified shipping address is input, the output unit displays a delivery product image corresponding to the simplified shipping address.

18. A method for supporting delivery service using a system for supporting delivery service, comprising:
generating a minimum unit shipping address in which a shipping address of shipping data is simplified into a form identifiable by a delivery person;
determining whether the generated minimum unit shipping address is duplicated to generate a simplified shipping address; and
generating output data for outputting the generated simplified shipping address,
wherein the generated minimum unit shipping address includes at least one character included in an identifier of the shipping address.

19. The method of claim 18, further comprising:
transmitting the output data to a printing device and printing the output data through the printing device.

20. The method of claim 18, further comprising transmitting the output data to a delivery person terminal and displaying the output data through the delivery person terminal.
